(19) United States
(12) Patent Application Publication
(10) Pub. No.: US 2016/0024620 A1
(43) Pub. Date: Jan. 28, 2016

(54) LAVES PHASE-RELATED BCC METAL HYDRIDE ALLOYS FOR ELECTROCHEMICAL APPLICATIONS

(71) Applicant: Ovonic Battery Company, Inc., Rochester Hills, MI (US)

(72) Inventors: Kwo-Hsiung Young, Troy, MI (US); Diana Wong, Sterling Heights, MI (US); Lixin Wang, Ypsilanti, MI (US)

(21) Appl. No.: 14/340,959

(22) Filed: Jul. 25, 2014

(51) Int. Cl. C22C 27/02; H01M 4/38; C22C 30/00

(52) U.S. Cl. CPC C22C 27/025; C22C 30/00; H01M 4/383; H01M 10/30

(57) ABSTRACT

Laves phase-related BCC metal hydride alloys historically have limited electrochemical capabilities. Provided are a new examples of these alloys useful as electrode active materials. Alloys include a composition defined by Formula I: Ti_{w}VₓCr_{y}M_{z} (I) where w+x+y+z=1, 0.1≦w≦0.6, 0.1≦x≦0.6, 0.01≦y≦0.6 and M is selected from the group consisting of B, Al, Si, Sn and one or more transition metals that achieve discharge capacities of 350 mAh/g or greater for cycles of 10 or more.

### STATEMENT OF GOVERNMENT SUPPORT

This invention was made with government support under contract no. DE-FOA-0000869 and control no. 0869-1630 awarded by United States Department of Energy. The government has certain rights in the invention.

### FIELD OF THE INVENTION

This invention relates to alloy materials and methods for their fabrication. In particular, the invention relates to metal hydride alloy materials that are capable of absorbing and desorbing hydrogen. Activated metal hydride alloys with a laves phase-related body centered cubic (BCC) structure are provided that have unique electrochemical properties including high capacity for use in electrochemical applications.

### BACKGROUND OF THE INVENTION

Certain metal hydride (MH) alloy materials are capable of absorbing and desorbing hydrogen. These materials can be used as hydrogen storage media, and/or as electrode materials for fuel cells and metal hydride batteries including nickel/metal hydride (Ni/MH) and metal hydride/air battery systems. However, due to limited gravimetric energy density (<110 Wh kg⁻¹), current Ni/MH batteries lose market share in portable electronic devices and the battery-powered electrical vehicle markets to the lighter Li-ion technology. As such, the next generation of Ni/MH batteries is geared toward improving two main targets: raising the energy density and lowering cost.

When an electrical potential is applied between the cathode and a MH anode in a MH cell, the negative electrode material (M) is charged by the electrochemical absorption of hydrogen to form a MH and the electrochemical evolution of a hydroxyl ion. Upon discharge, the stored hydrogen is released to form a water molecule and evolve an electron. The reactions that take place at the positive electrode of a Ni/MH cell are also reversible. Most Ni/MH cells use a nickel hydroxide positive electrode. The following charge and discharge reactions take place at a nickel hydroxide positive electrode.

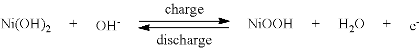

In a Ni/MH cell having a nickel hydroxide positive electrode and a hydrogen storage negative electrode, the electrodes are typically separated by a non-woven, felted, nylon or polypropylene separator. The electrolyte is usually an alkaline aqueous electrolyte, for example, 20 to 45 weight percent potassium hydroxide.

One particular group of MH materials having utility in Ni/MH battery systems is known as the ABₓ class of material with reference to the crystalline sites occupied by its member component elements. ABₓ type materials are disclosed, for example, in U.S. Pat. No. 5,536,591 and U.S. Pat. No. 6,210,498. Such materials may include, but are not limited to, modified LaNi₅ type (AB₅) as well as the Laves-phase based active materials (AB₂). These materials reversibly form hydrides in order to store hydrogen. Such materials utilize a generic Ti—Zr—Ni composition, where at least Ti, Zr, and Ni are present with at least one or more modifiers from the group of Cr, Mn, Co, V, and Al. The materials are multiphase materials, which may contain, but are not limited to, one or more Laves phase crystal structures and other non-Laves secondary phase. Current AB₅ alloys have ˜320 mAh g⁻¹ capacity and Laves-phase based AB₂ has a capacity up to 440 mAh g⁻¹ such that these are the most promising alloy alternatives with a good balance among high-rate dischargeability (HRD), cycle life, charge retention, activation, self discharge, and applicable temperature range.

Rare earth (RE) magnesium-based AB₃- or A₂B₇-types of MH alloys are promising candidates to replace the currently used AB₅ MH alloys as negative electrodes in Ni/MH batteries due in part to their higher capacities. While most of the RE-Mg—Ni MH alloys were based on La-only as the rare earth metal, some Nd-only A₂B₇ (AB₃) alloys have recently been reported. In these materials, the AB_{3.5} stoichiometry is considered to provide the best overall balance among storage capacity, activation, HRD, charge retention, and cycle stability. The pressure-concentration-temperature (PCT) isotherm of one Nd-only A₂B₇ alloy showed a very sharp take-off angle at the α-phase [K. Young, et al., Alloys Compd. 2010; 506: 831] which can maintain a relatively high voltage during a low state-of-charge condition. Compared to commercially available AB₅ MH alloys, a Nd-only A₂B₇ exhibited a higher positive electrode utilization rate and less resistance increase during a 60° C. storage, but also suffered higher capacity degradation during cycling [K. Young, et al., Int J. Hydrogen Energy, 2012; 37:9882]. Another issue with known A₂B₇ alloys is that they suffer from inferior HRD relative to the prior AB₅ alloy systems due to less Ni-content in the alloy chemical make-up.

Other ABₓ materials include the Laves phase-related body centered cubic (BCC) materials that are a family of MH alloys with a two-phase microstructure including a BCC phase and a Laves phase historically present as C14 as an example. These materials are based on a theoretical electrochemical capacity of 938 mAh g⁻¹ for Ti—V—Cr alloy with full BCC structure that unfortunately has very poor electrochemical properties. As such, Laves phase with similar chemical make-up is added to the BCC material. These Laves phase-related BCC materials exhibit high density of the phase boundaries that allow the combination of higher hydrogen storage capacity of BCC and good hydrogen absorption kinetics and relatively high surface catalytic activity of the C14 phase. Many studies have been undertaken to optimize these materials. Young et al., Int. Hydrogen Energy, http://dx.doi.org/10.1016/j.ijhydene.2014.01.134 (article in press) describes a systematic study of these materials with a broad range of BCC/C14 ratio. These results reveal that while these materials have many desirable properties, the electrochemical discharge capacity produced by these materials does not exceed 175 mAh/g.

As such, there is a need for improved hydrogen storage materials. As will be explained herein below, the present invention addresses these needs by providing activated Laves phase-related BCC metal hydride alloys that for the first time exhibit greatly improved electrochemical properties. These and other advantages of the invention will be apparent from the drawings, discussion, and description which follow.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

The alloy materials as described have improved capacities relative to prior alloys of similar composition as well as significantly improved cycle life at the high capacity. While some prior materials are capable of high capacity, this capacity decreases rapidly in 1-5 cycles. Improvements in cycle life in Laves phase-related BCC metal hydrides historically reduce capacity. The Laves phase-related BCC metal hydride alloys as provided herein solve the issue of reduced capacity and demonstrate greatly improved capacity over many more cycles by tailoring the ratio of Ti to Cr in the systems.

A Laves phase-related BCC metal hydride is provided that includes the composition of Formula I:

Ti_{w}VₓCr_{y}M_{z} (I)

where w+x+y+z=1, 0.1≦w≦0.6, 0.1≦x≦0.6, 0.01≦y≦0.6, and M is selected from the group consisting of B, Al, Si, Sn and transition metals, the metal hydride alloy having a capacity in excess of 350 milliamperes per gram at cycle 10. Some embodiments have a capacity of 400 milliamperes per gram or greater, optionally 420 milliamperes per gram or greater, at cycle 10. An alloy optionally includes less than 24% C14 phase. In some embodiments, the alloy is predominantly a combination of BCC phase and Laves phase, said BCC phase in abundance of greater than 5% and less than 95%, said Laves phase in abundance of greater than 5% and less than 95%. Optionally, the alloy includes a BCC phase crystallite size of less than 400 angstroms, optionally less than 200 angstroms. In some embodiments, the B/A ratio is 1.20 the 1.31, optionally 1.20 to 1.30. Optionally, the ratio x/y is from 1 to 3. Some embodiments of any of the foregoing include the composition of Formula II:

Ti_{13.6+x}Zr_{2.1}V₄₄Cr_{13.2-x}M_{27.1} (II)

where x is a value in excess of 0 and 12 or less, and M is a combination of Mn, Fe, Co, Ni, and Al. The alloy of Formula II optionally has x of 2, 4, 6, 8, 10 or 12.

The alloys provided and their equivalents represent superior materials for use in an anode of a cell or battery system.

### BRIEF DESCRIPTION OF THE DRAWINGS

FIG. 1A illustrates alloy phase distribution as observed in an SEM image of a hydrogen storage alloy of P8;

FIG. 1B illustrates alloy phase distribution as observed in an SEM image of a hydrogen storage alloy of P9;

FIG. 1C illustrates alloy phase distribution as observed in an SEM image of a hydrogen storage alloy of P10;

FIG. 1D illustrates alloy phase distribution as observed in an SEM image of a hydrogen storage alloy of P11;

FIG. 1E illustrates alloy phase distribution as observed in an SEM image of a hydrogen storage alloy of P12;

FIG. 1F illustrates alloy phase distribution as observed in an SEM image of a hydrogen storage alloy of P13;

FIG. 1G illustrates alloy phase distribution as observed in an SEM image of a hydrogen storage alloy of P14;

FIG. 2A illustrates the major constituent elements and the metal ratio in the C14 phase as a function of Ti-content in the alloy design;

FIG. 2B illustrates the major constituent elements and the metal ratio in the BCC phase as a function of Ti-content in the alloy design;

FIG. 3A illustrates the microstructure of hydrogen storage alloys activated to provide improved electrochemical properties and illustrating two predominant phases, C14 and BCC;

FIG. 3B illustrates the FWHM of the BCC (110) peak from control and hydrogen storage alloys activated to provide improved electrochemical properties and demonstrating the reduced crystallite size of the alloys activated by exemplary processes as described herein;

FIG. 4 illustrates a schematic of the C14 unit cell of the various alloys composed of alternating A2B and B3 layers stacked along the c axis while larger A-atoms occupy 4f-sites and smaller B-atoms occupy 2a-sites (on the A2B layer) and 6h-sites (on the B3 layer);

FIG. 5 illustrates the FWHM of the BCC (110) peak from control and hydrogen storage alloys activated to provide improved electrochemical properties and demonstrating the reduced crystallite size of the alloys activated by exemplary processes as described herein;

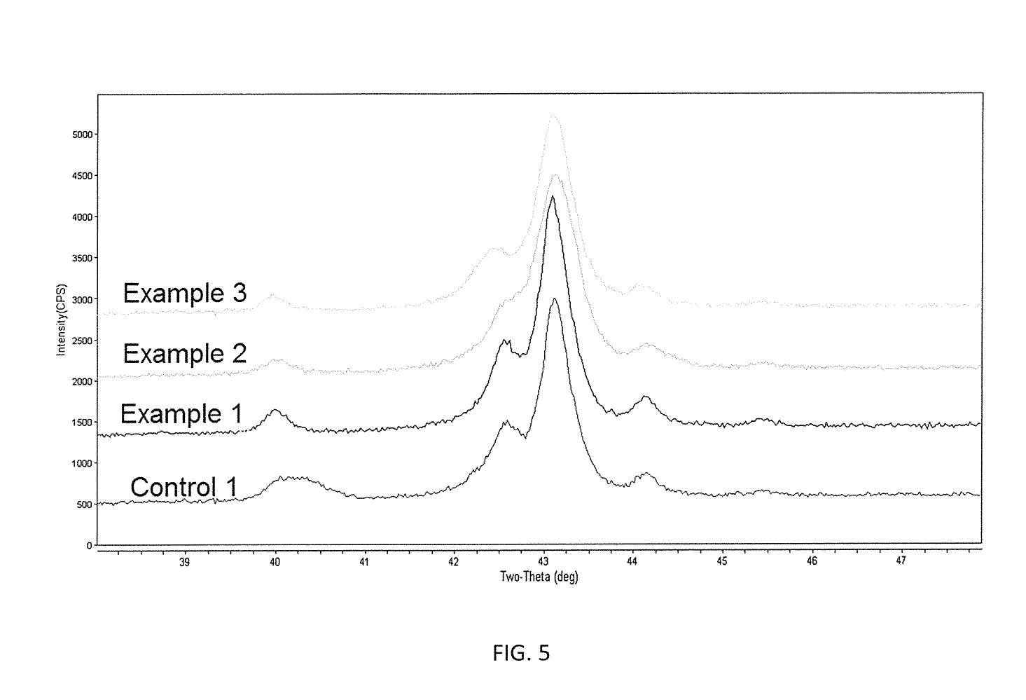

FIG. 6 illustrates gaseous phase hydrogen storage characteristics of various alloy materials formed by exemplary processes as described herein;

FIG. 7A illustrates gaseous phase hydrogen storage characteristics of various alloy materials;

FIG. 7B illustrates gaseous phase hydrogen storage characteristics of various alloy materials;

FIG. 8A illustrates the half-cell discharge capacity measured at 4 mA/g of the first 13 cycles;

FIG. 8B illustrates and high-rate dischargeability (FIRD) in the first 13 cycles;

FIG. 9 illustrates hydrogen storage capacities converted from gaseous phase hydrogen storage and as measured electrochemically as functions of alloy number; and

FIG. 10 illustrates diffusion coefficient and C14-phase crystallite size as functions of alloy number where the trends indicate that hydrogen diffuses easier within an alloy with smaller C14-phase crystallites.

### BRIEF DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly fotinal sense unless expressly so defined herein.

Hydrogen storage alloys having Laves phase-related BCC structures have been studied for some time to identify how to promote a synergistic effect between the C14 and BCC phases of the system. Prior studies substituting A-site and B-site elements have been performed on numerous mixed phase alloys some of which were found to increase or decrease C14 phase abundance. Compositional refinements have continued as a way to improve both the gaseous and electrochemical hydrogen storage properties of these alloys. While these efforts met with some success and often mixed conclusions, achieving capacities in excess of 200 mAh/g remained elusive. The alloys provided herein represent a simple and elegant solution to these problems by exhibiting hydrogen storage alloys of the Laves-phase related BCC structured materials that exhibit excellent electrochemical properties.

Provided are hydrogen storage alloys having a Laves phase-related BCC structure that exhibit excellent electrochemical properties unexpectedly superior to prior materials of similar composition. A Laves-phase related BCC metal hydride alloy of the composition of Formula I is provided.

Ti_{w}VₓCr_{y}M_{z} (I)

where w+x+y+z=1, 0.1≦w≦0.6, 0.1≦x≦0.6, 0.01≦y<0.6 and M is selected from the group consisting of B, Al, Si, Sn and one or more transition metals. The alloy is activated by particular processes to promote formation of increased BCC phase and limit AB₂ phase in the resulting materials. The result is an activated metal hydride alloy having improved electrochemical properties including a capacity at or in excess of 200 mAh/g, optionally 350 mAh/g or greater at cycle 10.

Optionally, a Laves-phase related BCC metal hydride alloy of the composition of Formula II:

Ti_{13.6+x}Zr_{2.1}V₄₄Cr_{13.2-x}M_{27.1} (II)

where x is a value in excess of 0 and 12 or less, and M is a combination of Mn, Fe, Co, Ni, and Al. Optionally x is 1, 2, 3, 4, 5, 6, 7, 8, 9, 10, 11, or 12, or any value between greater than 0 and 12 or less, including non-whole numbers. In some embodiments, x is 2, 4, 6, 8, 10, or 12. Optionally, x is 2 or 4.

In some embodiments, a Laves-phase related BCC metal hydride alloy includes a capacity well in excess of 200 mAh/g, optionally 220 mAh/g, 240 mAh/g, 260 mAh/g, 280 mAh/g, 300 mAh/g, 310 mAh/g, 320 mAh/g, 330 mAh/g, 340 mAh/g, 350 mAh/g, 360 mAh/g, 370 mAh/g, 380 mAh/g, 390 mAh/g, 400 mAh/g, 410 mAh/g, 420 mAh/g, 430 mAh/g, 440 mAh/g, 450 mAh/g, or more. Optionally, a metal hydride alloy includes a capacity between 200 and 450 mAh/g. Optionally, a metal hydride alloy includes a capacity between 300 and 450 mAh/g. Optionally, a metal hydride alloy includes a capacity between 350 and 450 mAh/g. Optionally, a metal hydride alloy includes a capacity between 400 and 450 mAh/g. Optionally, a metal hydride alloy includes a capacity between 400 and 420 mAh/g. In some embodiments, any of the foregoing capacities are optionally present at 2 or more cycles, optionally 3, 4, 5, 6, 7, 8, 9, 10, 11, 12, 13, 14, 15, 16, 17, 18, 19, 20, or more cycles. Optionally, a metal hydride alloy has a capacity at or in excess of 350 mAh/g at cycle 10, optionally at or in excess of 400 mAh/g at cycle 10, optionally at or in excess of 420 mAh/g at cycle 10.

The physical structure of the material along with its composition and lack of oxidation relative to prior alloy materials of similar chemical composition promote the excellent electrochemical properties of the metal hydride alloy. A metal hydride alloy optionally is predominantly formed of BCC phase and Laves phase structure. Without being limited to one particular theory, it is believed that the predominance of the structure being in the BCC phase and Laves phase increases a synergistic effect produced by the presence of the two phases. As such, the metal hydride alloy, optionally produced by the processes as disclosed herein, optionally has BCC phase in abundance of greater than 5% and less than 95%, a Laves phase in abundance of greater than 5% and less than 95% with the combination of BCC phase and Laves phase being in excess of 50% of the material structure. Optionally, the BCC phase is at or between 10% and 95%, 20% and 95%, 30% and 95%, 40% and 95%, 50% and 95%, 60% and 95%, 70% and 95%, or 80% and 95%, optionally also in any such instance with a Laves phase in excess of 5%. Optionally, the Laves phase is at or between 10% and 95%, 20% and 95%, 30% and 95%, 40% and 95%, 50% and 95%, 60% and 95%, 70% and 95%, or 80% and 95%, optionally also in any such instance with a BCC phase in excess of 5%. In some embodiments, composition has a C14 Laves phase that is less than 30%, optionally less than 25%, optionally less than 24%, optionally less than 20%, optionally less than 15%, optionally less than 14%, optionally, less than 13%, optionally less than 12%.

The hydrogen storage alloy is provided with a crystallite size of the BCC phase that is sufficiently small to allow a large inter-granular region and a higher synergetic connection between storage and catalytic phase to promote the electrochemical properties. The alloys as provided have a BCC crystallite size of 400 Å or less, optionally 390 Å or less, optionally 380 Å or less, optionally 370 Å or less, optionally 360 Å or less, optionally 350 Å or less, optionally 340 Å or less, optionally 330 Å or less, optionally 320 Å or less, optionally 310 Å or less, optionally 300 Å or less, optionally 290 Å or less, optionally 280 Å or less, optionally 270 Å or less, optionally 260 Å or less, optionally 250 Å or less, optionally 240 Å or less, optionally 230 Å or less, optionally 220 Å or less, optionally 210 Å or less, optionally 200 Å or less, optionally 19 Å or less, optionally 180 Å or less, optionally 170 Å or less, optionally 160 Å or less, optionally 150 Å or less, optionally 140 Å or less, optionally 130 Å or less, optionally 120 Å or less. Optionally, the crystallite size of the BCC phase is from 120 Å to 300 Å. Optionally, the crystallite size of the BCC phase is from 120 Å to 200 Å. Optionally, the crystallite size of the BCC phase is from 120 Å to 160 Å. Optionally, the crystallite size of the BCC phase is from 140 Å to 160 Å.

The physical, structural, and electrochemical properties of the hydrogen storage alloy are promoted by preventing too much Laves phase from forming in the material, increasing the amount of BCC phase structure to the material, or combinations thereof. As such, processes of activating (hydriding) a Laves phase-related BCC metal hydride alloy of Formula I or Formula II are provided. A process includes subjecting the Laves phase-related BCC metal hydride alloy to an atmosphere including hydrogen at a hydrogenation pressure and simultaneously cooling the alloy to produce an activated metal hydride alloy having the desired capacity, optionally 350 mAh/g at cycle 10. Subjecting a Laves phase-related BCC metal hydride alloy to hydrogen at elevated pressures will increase the temperature of the material due to the exothermic nature of the hydride formation reaction. It was discovered that allowing the temperature of the alloy to increase in an uncontrolled manner is detrimental to the resulting electrochemical properties of the activated alloy. As such, in some embodiments, the alloys are hydrogenated by a process that includes an active cooling step. Without being limited one particular theory, controlling the temperature of the material during hydriding promotes excess AB₂ phase structure from forming in the alloy during activation. Temperature control is achieved by cooling the reaction vessel such as with a water jacketed system or bath, or by other methods known in the art. Optionally, the reaction temperature of the alloy does not exceed 300° C.

In some embodiments, the temperature of the alloy is maintained during hydrogenation between room temperature and optionally 300° C., optionally 295° C., optionally 290° C., optionally 285° C., optionally 280° C., optionally 275° C., optionally 270° C., optionally 260° C., optionally 250° C., optionally 240° C., optionally 230° C., optionally 220° C., optionally 210° C., optionally 200° C., optionally 190° C., optionally 180° C., optionally 170° C., optionally 160° C., optionally 150° C., optionally 140° C., optionally 130° C., optionally 120° C., optionally 110° C., optionally 100° C., optionally 90° C., optionally 80° C., optionally 70° C., optionally 60° C., optionally 50° C., optionally 40° C., optionally 30° C. In some embodiments, an alloy is maintained during hydrogenation to a temperature between room temperature and 300° C., or to any value or range therebetween.

Increasing hydrogen pressure was also discovered to be useful to promote formation of increased amounts of BCC phase in the resulting activated hydrogen storage alloy. As such, a some embodiments hydrogenating the Laves phase-related BCC metal hydride alloy is performed at a hydrogenation pressure of 1.4 MPa or greater, optionally 1.5 MPa or greater, optionally 1.8 MPa or greater, optionally 2 MPa or greater, optionally 3 MPa or greater, optionally 4 MPa or greater, optionally 5 MPa or greater, optionally 6 MPa or greater.

In some embodiments, the Laves phase-related BCC metal hydride alloy is hydrogenated using both a hydrogenation pressure in excess of 1.4 MPa and controlling the temperature to 300° C. or less. As such, an alloy is optionally activating with a hydrogenation pressure of between 1.4 MPa to 6 MPa, or greater, with cooling to prevent the alloy from exceeding 300° C., optionally 295° C., optionally 290° C., optionally 285° C., optionally 280° C., optionally 275° C., optionally 270° C., optionally 260° C., optionally 250° C., optionally 240° C., optionally 230° C., optionally 220° C., optionally 210° C., optionally 200° C., optionally 190° C., optionally 180° C., optionally 170° C., optionally 160° C., optionally 150° C., optionally 140° C., optionally 130° C., optionally 120° C., optionally 110° C., optionally 100° C., optionally 90° C., optionally 80° C., optionally 70° C., optionally 60° C., optionally 50° C., optionally 40° C., optionally 30° C. At any one of the above temperature ranges the hydrogenation pressure is optionally between 6 MPa and optionally 1.4 MPa, optionally 1.5 MPa, optionally 1.6 MPa, optionally 1.7 MPa, optionally 1.8 MPa, optionally 1.9 MPa, optionally 2 MPa, optionally 2.1 MPa, optionally 2.2 MPa, optionally 2.3 MPa, optionally 2.4 MPa, optionally 2.5 MPa, optionally 2.6 MPa, optionally 2.7 MPa, optionally 2.8 MPa, optionally 2.9 MPa, optionally 3 MPa, optionally 3.1 MPa, optionally 3.2 MPa, optionally 3.3 MPa, optionally 3.4 MPa, optionally 3.5 MPa, optionally 3.6 MPa, optionally 3.7 MPa, optionally 3.8 MPa, optionally 3.9 MPa, optionally 4 MPa, optionally 4.1 MPa, optionally 4.2 MPa, optionally 4.3 MPa, optionally 4.4 MPa, optionally 4.5 MPa, optionally 4.6 MPa, optionally 4.7 MPa, optionally 4.8 MPa, optionally 4.9 MPa, optionally 5 MPa, optionally 5.1 MPa, optionally 5.2 MPa, optionally 5.3 MPa, optionally 5.4 MPa, optionally 5.5 MPa, optionally 5.6 MPa, optionally 5.7 MPa, optionally 5.8 MPa, optionally 5.9 MPa. In some embodiments the hydrogenation pressure is 6 MPa or greater.

The resulting activated hydrogen storage alloy produced by the provided processes possesses capacities that nearly double and often more than double those of compositionally similar materials produced in traditional manners.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### EXPERIMENTAL

A series of metal hydride alloys of Formula I or II were prepared and hydrided by various conditions in connection with an experimental series illustrating the principles of the present invention. The raw materials were arc melted under conditions of continuous argon flow using a non-consumable tungsten electrode and a water cooled copper tray. Prior to formation, the residual oxygen concentration in the system was reduced by subjecting a piece of sacrificial titanium to several melt-cool cycles. Study ingots where then subjected to several re-melt cycles with turning over to ensure uniformity in chemical composition.

The chemical composition of the prepared alloy samples was determined using a Varian Liberty 100 inductively coupled plasma optical emission spectrometer (ICP-OES) in accord with principles known in the art. The ICP results from ingots prior to activation in atomic percentage are illustrated in Table 1:

TABLE 1
Design compositions and ICP results

| | | Ti | Zr | V | Cr | Mn | Fe | Co | Ni | Al | B/A ratio |
|---|---|---|---|---|---|---|---|---|---|---|---|
| P8 | Design | 13.6 | 2.1 | 44.0 | 13.2 | 6.9 | 2.7 | 1.4 | 15.7 | 0.3 | 5.36 |
| | ICP | 13.8 | 2.0 | 43.1 | 13.1 | 6.5 | 2.8 | 1.4 | 16.7 | 0.6 | 5.33 |
| P9 | Design | 15.6 | 2.1 | 44.0 | 11.2 | 6.9 | 2.7 | 1.4 | 15.7 | 0.3 | 4.64 |
| | ICP | 15.8 | 2.0 | 44.6 | 11.1 | 6.5 | 2.7 | 1.4 | 15.5 | 0.3 | 4.61 |
| P10 | Design | 17.6 | 2.1 | 44.0 | 9.2 | 6.9 | 2.7 | 1.4 | 15.7 | 0.3 | 4.07 |
| | ICP | 18.1 | 2.1 | 43.6 | 9.3 | 6.5 | 2.8 | 1.5 | 15.8 | 0.3 | 3.95 |
| P11 | Design | 19.6 | 2.1 | 44.0 | 7.2 | 6.9 | 2.7 | 1.4 | 15.7 | 0.3 | 3.60 |
| | ICP | 19.9 | 2.1 | 44.1 | 6.8 | 6.6 | 2.7 | 1.5 | 16.0 | 0.3 | 3.55 |
| P12 | Design | 21.6 | 2.1 | 44.0 | 5.2 | 6.9 | 2.7 | 1.4 | 15.7 | 0.3 | 3.22 |
| | ICP | 22.1 | 2.1 | 43.6 | 5.4 | 6.6 | 2.7 | 1.5 | 15.7 | 0.3 | 3.13 |
| P13 | Design | 23.6 | 2.1 | 44.0 | 3.2 | 6.9 | 2.7 | 1.4 | 15.7 | 0.3 | 2.89 |
| | ICP | 23.7 | 2.5 | 43.9 | 3.3 | 6.5 | 2.7 | 1.4 | 15.7 | 0.3 | 2.82 |
| P14 | Design | 25.6 | 2.1 | 44.0 | 1.2 | 6.9 | 2.7 | 1.4 | 15.7 | 0.3 | 2.61 |
| | ICP | 26.1 | 2.3 | 43.8 | 1.1 | 6.5 | 2.7 | 1.3 | 15.8 | 0.3 | 2.52 |

The as-cast compositions are in excellent agreement with the composition as designed. The previous series of alloys showed unevenness in Cr content, and this has been improved by increasing the power during arc melting. The measured B/A ratio of this series of alloys (P8-P14) varies from 2.61 to 5.36, and the range is similar to the previous series (P1-P8) from Young et al., Int. J. Hydrogen Energy, http://dx.doi.org/10.1016/j.ijhydene.2014.01.134 (article in press).

### Phase Distribution and Composition

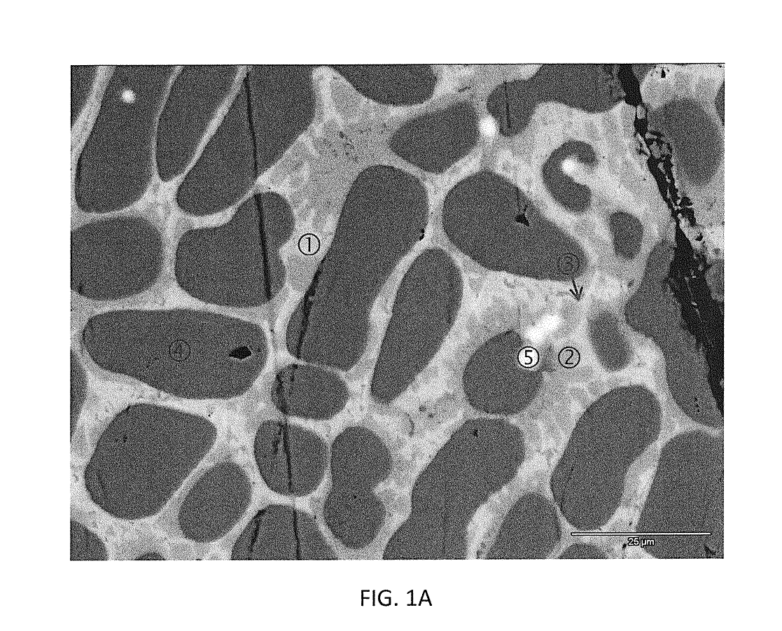

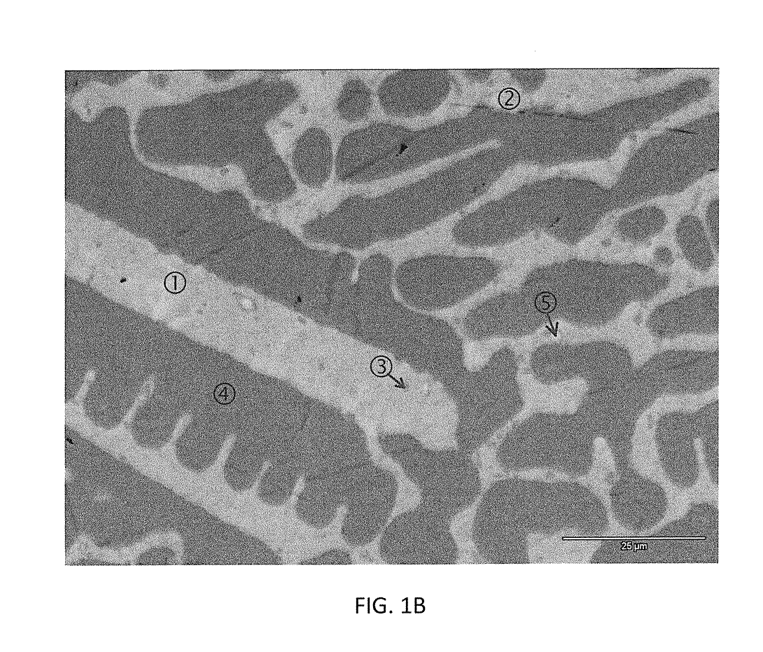

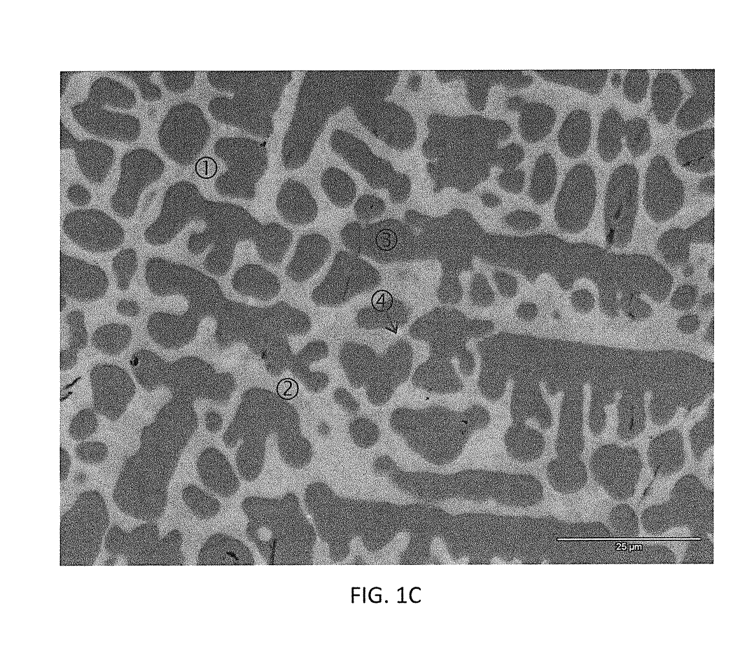

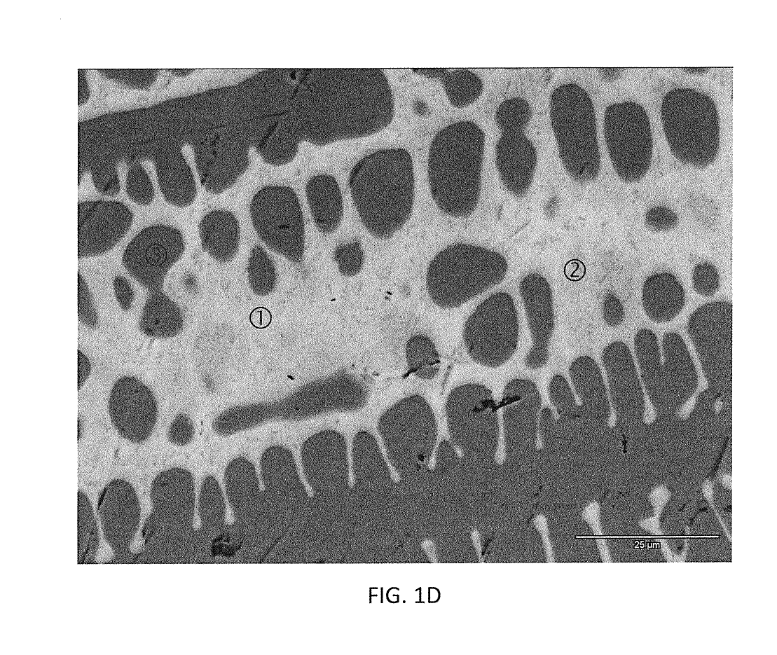

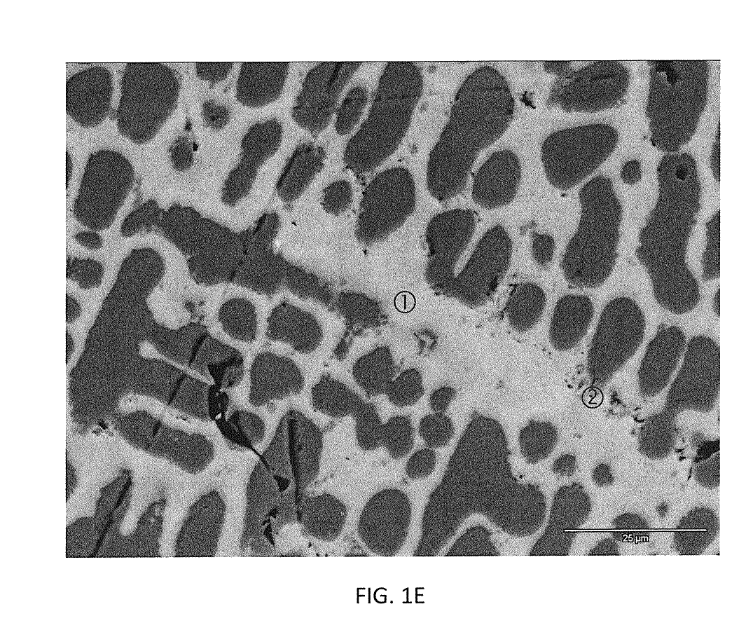

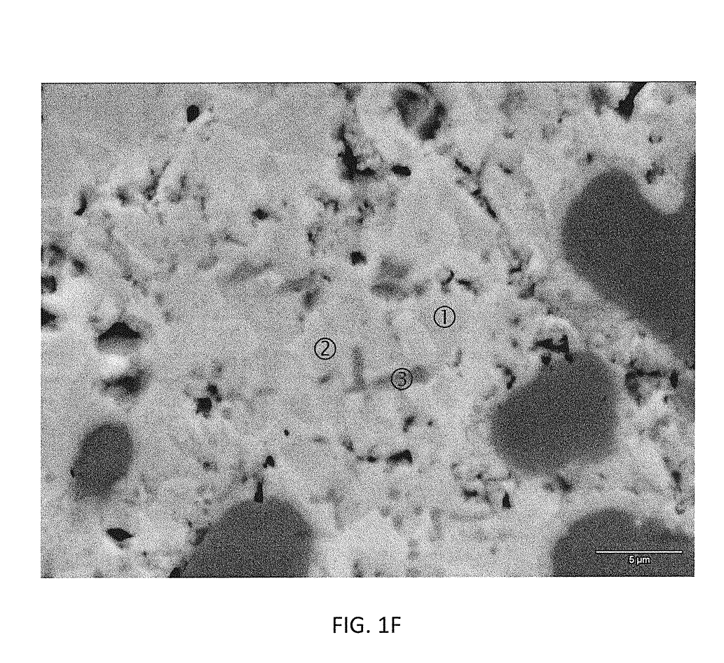

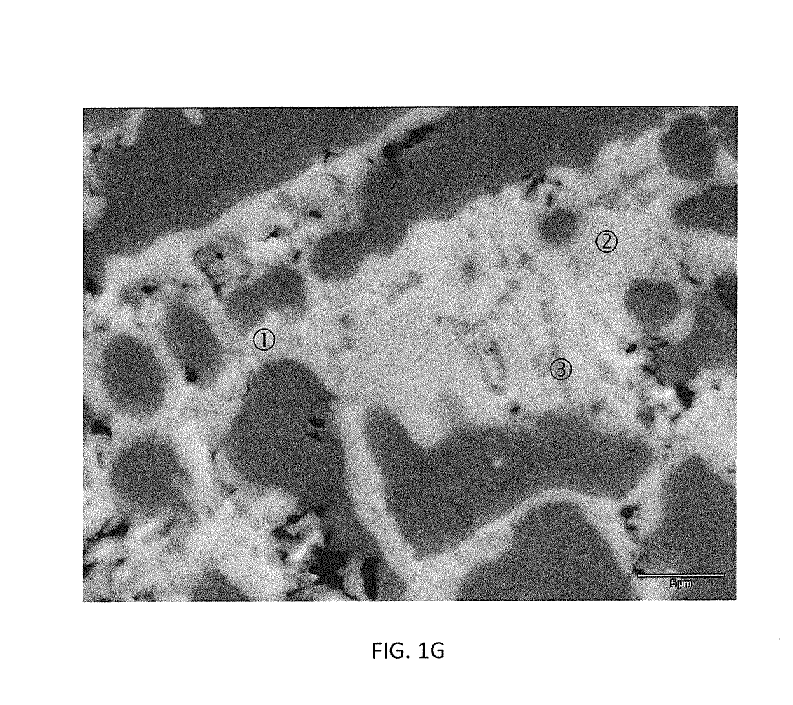

The alloy phase distribution and composition were examined using a JEOL-JSM6320F scanning electron microscope with energy dispersive spectroscopy (EDS) capability. Samples were mounted and polished on epoxy blocks, rinsed and dried before entering the SEM chamber. Back scattering electron images are presented in FIGS. 1A-G. Several areas are chosen for study by EDS which are each depicted with a numeral in FIGS. 1A-G. The results of the EDS measurements are illustrated in Table 2 illustrating the compositions of compositions P8-P14 in FIGS. 1A-1G respectively.

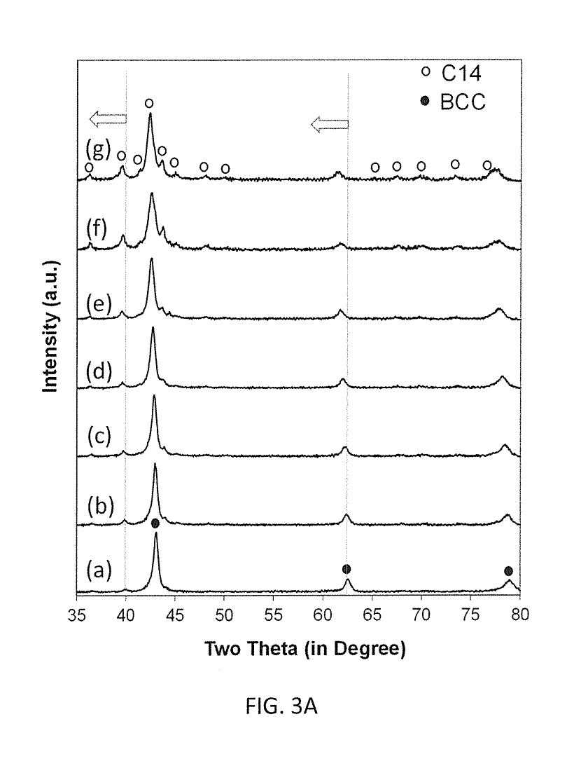

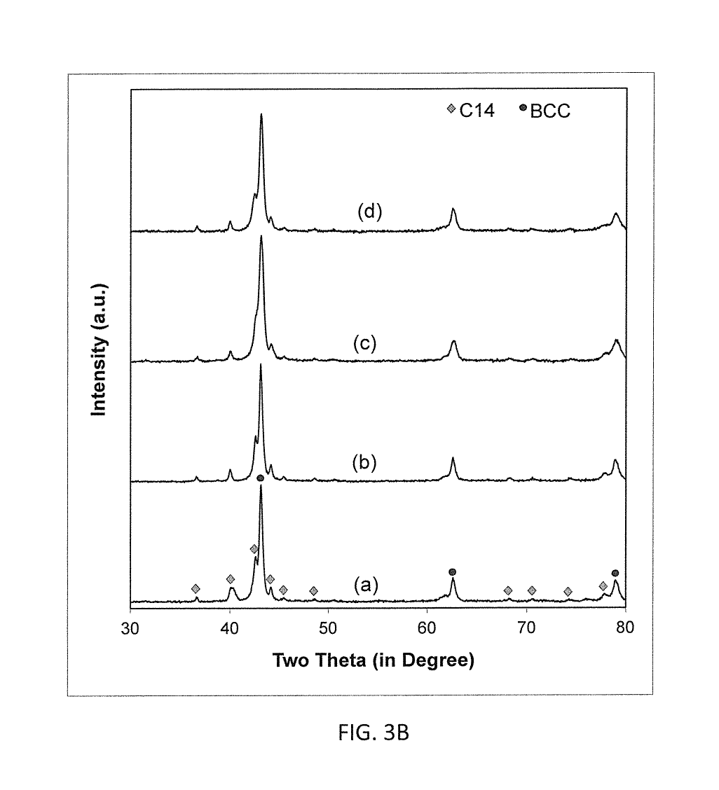

TABLE 2
Summary of EDS results. All compositions are in atomic percent. Compositions of
C14 and BCC phase are in italic and bold, respectively.

| | | Zr | Ti | V | Cr | Mn | Fe | Co | Ni | Al | B/A | Phase |
|---|---|---|---|---|---|---|---|---|---|---|---|---|
| FIG. 3a- | 1 | 8.8 | 23.3 | 18.8 | 2.6 | 7.7 | 3.7 | 1.9 | 32.3 | 1.0 | 2.12 | AB₂ |
| | 2 | 2.6 | 35.0 | 9.8 | 1.7 | 3.9 | 2.9 | 3.3 | 39.6 | 1.2 | 1.66 | Zr₇Ni₁₀ |
| | 3 | 8.2 | 35.1 | 16.1 | 1.4 | 4.5 | 2.0 | 1.4 | 30.8 | 0.5 | 1.31 | ZrₓNi_{y} |
| | 4 | 0.1 | 6.1 | 58.6 | 19.2 | 6.7 | 2.7 | 0.8 | 5.4 | 0.4 | 15.13 | BCC |
| | 5 | 93.1 | 1.6 | 2.8 | 1.0 | 0.3 | 0.2 | 0.1 | 0.9 | 0.1 | 0.06 | Zr |
| FIG. 3b- | 1 | 8.5 | 25.4 | 20.8 | 2.9 | 6.3 | 2.5 | 1.6 | 31.3 | 0.7 | 1.95 | AB₂ |
| | 2 | 3.3 | 36.8 | 9.5 | 1.2 | 3.0 | 1.8 | 2.4 | 41.3 | 0.8 | 1.50 | Zr₇Ni₁₀ |
| | 3 | 5.1 | 39.8 | 14.8 | 2.3 | 4.2 | 2.7 | 2.1 | 28.6 | 0.3 | 1.22 | ZrₓNi_{y} |
| | 4 | 0.1 | 7.1 | 60.8 | 16.4 | 7.0 | 2.6 | 0.8 | 4.9 | 0.3 | 12.89 | BCC |
| | 5 | 50.0 | 24.8 | 8.7 | 1.2 | 1.7 | 1.2 | 1.0 | 11.2 | 0.2 | 0.34 | Zr |
| FIG. 3c- | 1 | 7.7 | 28.5 | 20.2 | 2.3 | 6.6 | 2.9 | 1.8 | 29.3 | 0.6 | 1.76 | AB₂ |
| | 2 | 2.5 | 38.9 | 9.2 | 1.4 | 3.5 | 3.2 | 3.4 | 37.2 | 0.6 | 1.41 | Zr₇Ni₁₀ |
| | 3 | 0.1 | 7.8 | 63.7 | 14.6 | 6.0 | 2.3 | 0.8 | 4.5 | 0.3 | 11.67 | BCC |
| | 4 | 36.1 | 18.2 | 21.3 | 3.4 | 2.9 | 1.8 | 1.4 | 14.5 | 0.4 | 0.84 | Zr |
| FIG. 3d- | 1 | 6.4 | 30.9 | 21.6 | 2.0 | 7.2 | 3.2 | 1.9 | 26.4 | 0.6 | 1.69 | AB₂ |
| | 2 | 2.5 | 40.7 | 8.0 | 0.8 | 3.6 | 3.5 | 3.5 | 36.9 | 0.4 | 1.31 | ZrₓNi_{y} |
| | 3 | 0.1 | 9.3 | 65.1 | 10.9 | 6.7 | 2.3 | 0.9 | 4.5 | 0.3 | 9.65 | BCC |
| FIG. 3e- | 1 | 5.8 | 32.5 | 22.8 | 1.2 | 5.4 | 2.3 | 1.6 | 27.8 | 0.6 | 1.61 | AB₂ |
| | 2 | 2.3 | 41.6 | 8.3 | 0.5 | 3.3 | 3.3 | 3.5 | 36.7 | 0.5 | 1.28 | ZrₓNi_{y} |
| | 3 | 0.1 | 11.0 | 65.4 | 8.0 | 7.2 | 2.5 | 0.7 | 4.7 | 0.4 | 8.01 | BCC |
| FIG. 3f- | 1 | 4.7 | 34.5 | 21.5 | 1.1 | 7.1 | 2.7 | 1.5 | 26.4 | 0.5 | 1.55 | AB₂ |
| | 2 | 2.1 | 42.3 | 10.0 | 0.5 | 3.7 | 2.5 | 2.4 | 36.2 | 0.3 | 1.25 | ZrₓNi_{y} |
| | 3 | 2.9 | 48.1 | 12.3 | 0.4 | 4.0 | 2.3 | 1.9 | 27.7 | 0.4 | 0.96 | TiNi |
| | 4 | 0.1 | 13.5 | 64.9 | 5.5 | 7.1 | 3.0 | 0.8 | 4.8 | 0.2 | 6.35 | BCC |
| FIG. 3g- | 1 | 2.9 | 37.9 | 19.0 | 0.4 | 5.3 | 2.9 | 2.3 | 28.9 | 0.5 | 1.45 | AB₂ |
| | 2 | 1.9 | 42.2 | 9.8 | 0.1 | 4.3 | 3.5 | 3.1 | 34.6 | 0.5 | 1.27 | ZrₓNi_{y} |
| | 3 | 3.3 | 47.7 | 13.2 | 0.2 | 4.6 | 2.6 | 2.1 | 26.1 | 0.2 | 0.96 | TiNi |
| | 4 | 0.1 | 14.8 | 65.2 | 1.9 | 9.2 | 2.8 | 0.8 | 4.8 | 0.3 | 5.70 | BCC |

As the Ti-content increases in the alloy, both the grain sizes of the BCC and C14 phases decrease and then increase. Un-reacted metallic Zr was found in the first few alloys (FIG. 1A spot 5). Also, increases in the Ti-content produced increases in C14 phase abundance and thus less un-alloyed Zr can be found in the final sample. TiNi phase starts to appear in alloys P13 and P14, as shown in FIG. 1F-3 and FIG. 1G-3, the alloys with the highest Ti-content in the study.

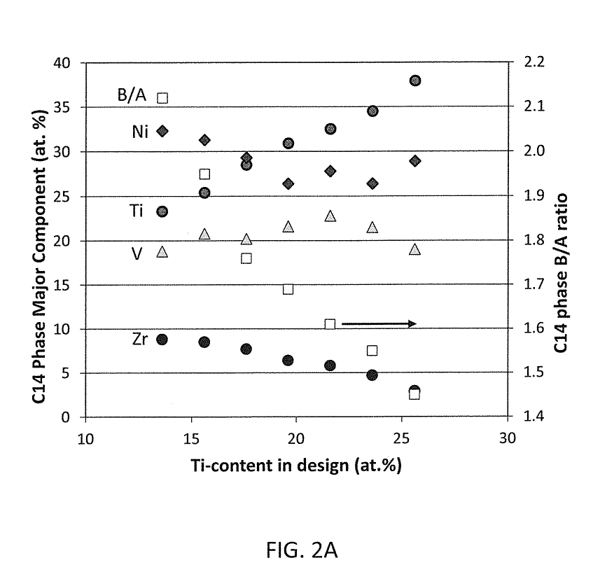

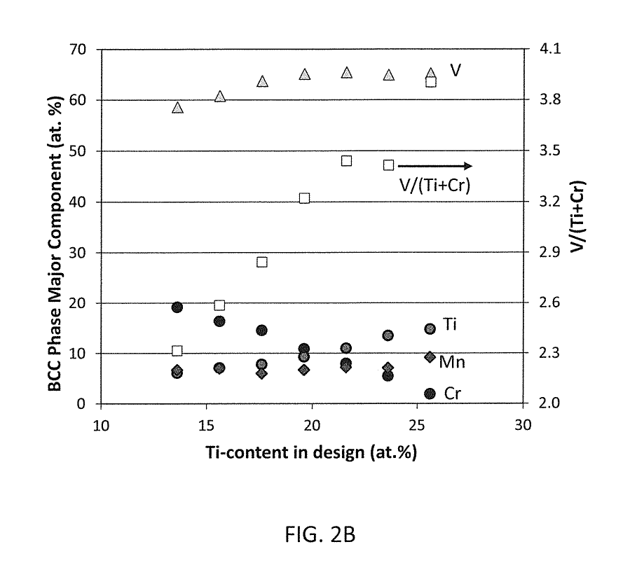

The Zr-, Ti-, V-, Ni-contents and the B/A ratio in C14 phase are plotted in FIG. 2A. As the overall Ti-content in the alloy increases, the Ti-content in the C14 phase increases linearly while Zr-content decreases; the Ni-content decreases and then stabilizes; the V-content stays about level; and the B/A ratio reduces from 2.1 to 1.5 monotonically.

### Hydriding

The alloys of P8-P14 are subjected to various activation conditions by varying either the maximum temperature of the alloy during activation through cooling the system, by altering the hydrogen pressure, or both. Four activation processes are depicted in Table 3.

TABLE 3
Exemplary Activation Conditions

| As cast | Hand grind (mortar & pestle) |
|---|---|
| Control | 1.4 MPa activation @350° C. Heat |
| | Degas @350° C. for 1 hour |
| | 1.4 MPa Stabilization @350° C. Heat |
| | Degas @350° C. for 1 hour |
| | 1.4 MPa Stabilization @350° C. Heat |
| | Degas @300° C. for 1 hour |
| | 1.2 MPa Manual PCT @60° C. |
| | Degas @300° C. for 1 hour |
| | 1.2 MPa Manual PCT @30° C. |
| | Degas @300° C. for 1 hour |
| | Hand grind (mortar & pestle) |
| Example 1 | 1.4 MPa activation @300° C. Heat |
| | Degas @300° C. for 1 hour |
| | 1.4 MPa Stabilization @300° C. Heat |
| | Degas @300° C. for 1 hour |
| | 1.4 MPa Stabilization @300° C. Heat |
| | Degas @300° C. for 1 hour |
| | Hand grind (mortar & pestle) |
| Example 2 | 6 MPa activation + Desorption @30° C. |
| | 6 MPa Auto PCT @30° C. |
| | 6 MPa Auto PCT @60° C. |
| | Degas @300° C. for 1 hour |
| | Hand grind (mortar & pestle) |
| Example 3 | 6 MPa activation |
| | Degas @30° C. for 1 hour |
| | Hand grind (mortar & pestle) |

The activated alloys of the control using traditional activation methods and those produced as per the processes of Examples 1-3 are subjected to analyses for gas phase hydrogen storage characteristics and electrochemical properties as well as structural arrangements.

### XRD Analyses

Microstructure of the alloys was studied utilizing a Philips X'Pert Pro x-ray diffractometer. The XRD patterns of all seven alloys P8-P 14 are illustrated in FIG. 3A (a-g respectively). It is clear that both C14 and BCC diffraction peaks are observed. Increasing V in the alloy corresponds to a decrease in the BCC peaks in intensity and a shift to lower angles, and the C 14 peaks increase in intensity and shift in the same direction as the BCC peaks.

The XRD patterns of the P8 samples hydrogenated under various conditions (control and Examples 1-3) are shown in FIG. 3B. Two sets of diffraction peaks are observed, C14 and BCC, indicating the significance of these structures in the overall system.

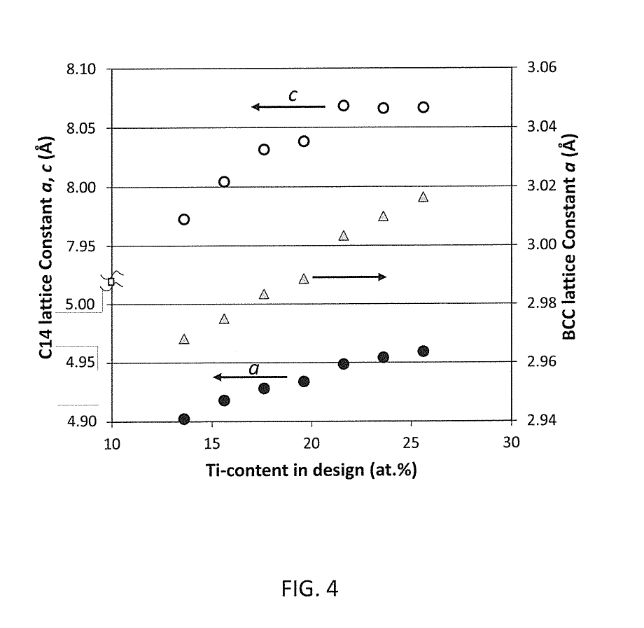

The crystallite sizes of each phase in all alloy samples are obtained from full pattern fitting of the XRD data using the Rietveld method and Jade 9 software. Lattice constants of both phases calculated from the XRD patterns are listed in Table 4 and plotted in FIG. 4.

TABLE 4

| | C14 phase | | | | | | |
|---|---|---|---|---|---|---|---|
| | | | | | | | Abun- |
| | | | | Unit cell | FWHM | | dance |
| | a (Å) | c (Å) | c/a | vol. (Å³) | (103) | XS (Å) | (%) |
| P8 | 4.9024 | 7.9728 | 1.626 | 165.94 | 0.504 | 185 | 11 |
| P9 | 4.9179 | 8.0045 | 1.628 | 167.65 | 0.408 | 237 | 20.8 |
| P10 | 4.928 | 8.0316 | 1.63 | 168.91 | 0.427 | 225 | 22.2 |
| P11 | 4.9339 | 8.0385 | 1.629 | 169.46 | 0.446 | 213 | 25.9 |
| P12 | 4.9487 | 8.0682 | 1.63 | 171.11 | 0.498 | 188 | 35.9 |
| P13 | 4.9542 | 8.066 | 1.628 | 171.44 | 0.465 | 175 | 56.4 |
| P14 | 4.9592 | 8.0666 | 1.627 | 171.8 | 0.482 | 163 | 52.5 |

BCC phase

| | | | | Abundance |
|---|---|---|---|---|
| | a (Å) | FWHM (200) | XS (Å) | (%) |
| P8 | 2.9683 | 0.646 | 155 | 89 |
| P9 | 2.9751 | 0.667 | 149 | 79.2 |
| P10 | 2.9835 | 0.688 | 144 | 77.8 |
| P11 | 2.9888 | 0.685 | 144 | 74.1 |
| P12 | 3.0034 | 0.724 | 136 | 64.1 |
| P13 | 3.01 | 0.774 | 126 | 43.6 |
| P14 | 3.0165 | 0.814 | 120 | 47.5 |

As the amount of Ti increases, lattice constants a and c for the C14 phase and lattice constant a for the BCC phase both show increases. In the C14 phase, the c/a ratio increases, stabilizes, and decreases as the Ti-content increases. The anisotropic growth of the C14 unit cell arises from the partial replacement of B-site Cr (metallic radius in AB₂ intermetallic alloy of 1.423 Å) with the relatively larger A-site Ti (radius of 1.614 Å). Lattice constant a in BCC phase increases from 2.9683 to 3.0165 Å as the V-content in the alloy increases.

Table 4 also illustrates the crystallite sizes of each phase in the P8-P14 alloys. As the Ti-content in the alloy increases, the abundance of the C14 phase increases from 11.0 to 56.4 wt. % and drops slightly to 52.5 wt. % in alloy P14. The BCC phase shows the reverse trend dropping from 89.0% to 47.5% from P8 to P14. At the same time, the C14 crystallite size first increases and then decreases, while the BCC crystallite size decreases monotonically.

FIG. 4 illustrates the FWHM of the BCC peak (110) for sample P8 as it is varied between the control and the samples hydrogenated by the methods of Examples 1-3. The calculated crystallite sizes of the BCC phase are presented in Table 5.

TABLE 5
Crystallite sizes of the BCC (110) phase.

| | | BCC Phase Crystallite |
|---|---|---|
| | HWHM (°) | Size (Å) |
| Control 1 | 0.27 | 406 |
| Example 1 | 0.341 | 298 |
| Example 2 | 0.474 | 201 |
| Example 3 | 0.393 | 251 |

Each of the exemplary hydrogenated materials show crystallite sizes of the BCC phase of less than 300 Å.

Lattice constants a and c from each of the hydrogenated P8 samples are listed in Table 6.

TABLE 6

| | a | c |
|---|---|---|
| Control 1 | 4.9004 | 7.9302 |
| Example 1 | 4.9005 | 7.9761 |
| Example 2 | 4.8939 | 7.9737 |
| Example 3 | 4.909 | 7.9916 |

### Gaseous Phase Characteristics

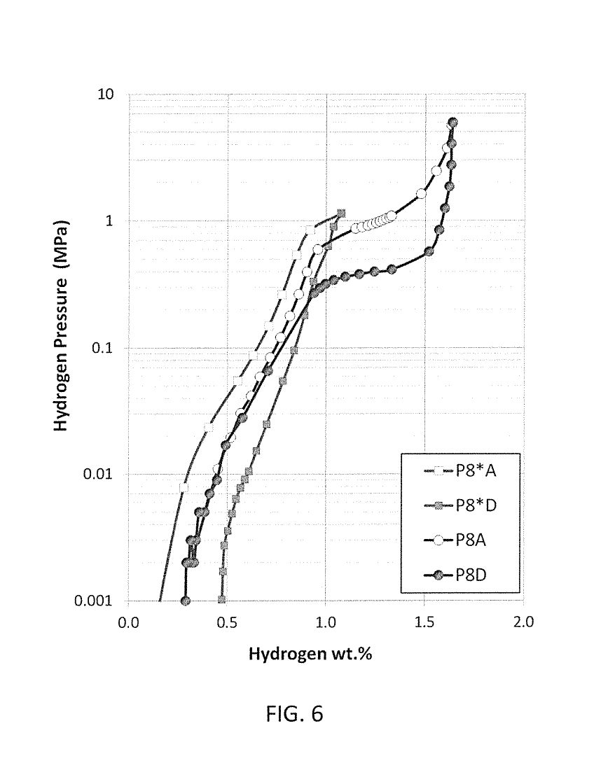

The gaseous phase hydrogen storage characteristics of the control and of Examples 1-3 were measured using a Suzuki-Shokan multi-channel pressure-concentration-temperature (PCT) system. The PCT isotherms at 30° C. and 60° C. were then measured. The resulting absorption and desorption isotherms for alloy P8 hydrogenated as per control and as per Example 1 are presented in FIG. 6. The alloy of P8 hydrogenated as per control shows significant hysteresis and does not exceed 1.1% hydrogen weight percentage after activation. The same material activated by a process that uses the identical hydrogen gas pressure, but controls the maximum temperature of the alloy during activation so as not to exceed 300° C. shows completion of the second plateau and hydrogen weight percentage above 1.5%.

The hysteresis of the PCT isotherm is defined as In (Pₐ/P_{d}), where Pₐ and P_{d} are the absorption and desorption equilibrium pressures at the mid-point of desorption isotherm, respectively. The hysteresis can be used to predict the pulverization rate of the alloy during cycling. Alloys with larger hysteresis have higher pulverization rates during hydriding/dehydriding cycles. From the hysteresis, a large increase in cycle stability is expected by activating according to the processes of Examples 1-3. Particularly, by cooling the ingot during activation so that the maximum temperature does not exceed 300° C., the hysteresis decreases significantly.

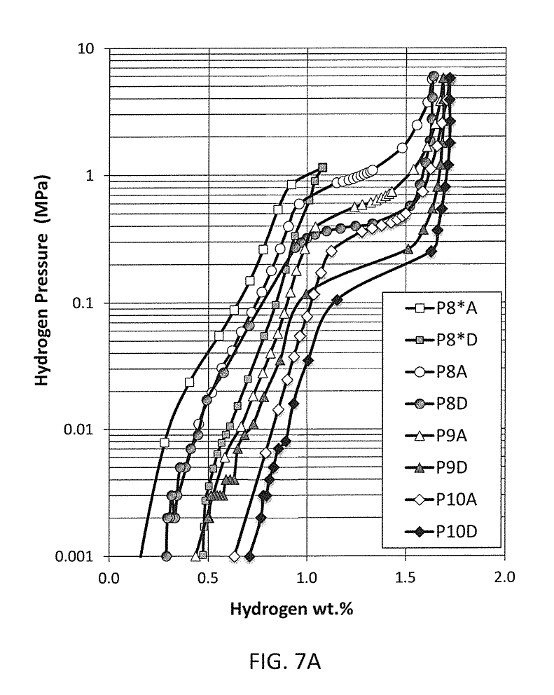

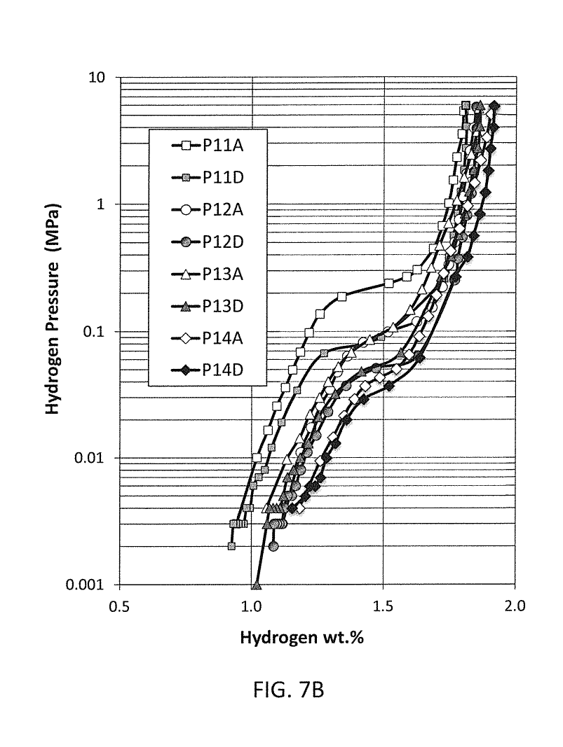

The alloys of P8-P14 are similarly hydrogenated for PCT studies. All samples are activated with one thermal cycle in the presence of hydrogen at the maximum pressure (5.0 MPa). Consequent measurements did not change the PCT characteristic significantly. The resulting absorption and desorption isotherms measured at 30 and 60° C. are shown in FIGS. 7A and B. As depicted in FIG. 7A, as a comparator, sample P8* was activated and measured with the maximum hydrogen pressure set at 1.1 MPa while all other samples were measured up to 5 MPa. Information obtained from the PCT study is summarized in Table 7.

TABLE 7
Summary of gaseous phase and thermodynamic properties. Desorption pressure,
hysteresis, and thermodynamic properties are calculated at 1.3 wt. % for P8-P10 and 1.5 wt. % for
P11-P14.

| | Des. | Des. | | | Max. | Rev. | | |
|---|---|---|---|---|---|---|---|---|
| | pressure | pressure | PCT | PCT | cap. | cap. | −ΔH | −ΔS |
| | @ 30° C. | @ 60° C. | hysteresis | hysteresis | @ 30° C. | @ 30° C. | (kJ | (J mol⁻¹ |
| | (MPa) | (MPa) | @ 30° C. | @ 60° C. | (wt. %) | (wt. %) | mol⁻¹) | K⁻¹) |
| P8* | NA | NA | NA | NA | 1.08 | 0.61 | 44.6 | 131 |
| P8 | 0.41 | 1.55 | 0.92 | 0.71 | 1.63 | 1.40 | 37.2 | 134 |
| P9 | 0.20 | 0.70 | 1.09 | 0.95 | 1.69 | 1.23 | 35.4 | 123 |
| P10 | 0.14 | 0.44 | 0.98 | 0.94 | 1.72 | 1.01 | 32.6 | 110 |
| P11 | 0.097 | 0.32 | 0.97 | 2.01 | 1.81 | 0.88 | 33.3 | 110 |
| P12 | 0.053 | 0.19 | 0.59 | 1.96 | 1.85 | 0.77 | 35.7 | 126 |
| P13 | 0.059 | 0.21 | 0.52 | 0.47 | 1.86 | 0.84 | 36.2 | 115 |
| P14 | 0.035 | 0.16 | 0.24 | 0.14 | 1.92 | 0.80 | 41.8 | 129 |

Equilibrium pressures in the desorption curves at 1.3 and 1.5 wt. % hydrogen storage were used as the plateau pressure for alloys P8-P10 and alloys P11-P14, respectively; and they show a decreasing trend with the increase in Ti-content. The lower equilibrium pressure arises from the expanded unit cells in both BCC and C14 phases. Hysteresis of the PCT isotherm is defined as ln(Pₐ/P_{d}), where Pₐ and P_{d} are the absorption and desorption equilibrium pressures at the stated hydrogen storage concentrations, respectively. In general, the hysteresis decreases as the Ti-content increases, which is expected to increase the cycle stability by reducing the pulverization during cycling. As the Ti-content increases, the maximum capacity increases due to the size of the larger unit cell and its capability to accommodate more hydrogen; but the reversible hydrogen storage capacity decreases due to the increase in the metal-hydrogen bond strength (judging from the lower equilibrium pressure). The desorption equilibrium pressures at 30, 60, and 90° C. were used to estimate the changes in enthalpy (ΔH) and entropy (ΔS) by the equation

ΔG=ΔH−TΔS=RT ln P (2)

where R is the ideal gas constant and T is the absolute temperature. Results of these calculations are listed in Table 7. The values are primarily useful for comparison among these alloys. As the Ti-content in the alloys increases, both −ΔH and −ΔS first decrease and then increase. The ΔH value does not correlate with the plateau pressure, which is rarely observed in alloys with a single dominant phase. The ΔS is an indication of how far the MH system is from a perfect, ordered state (degree of disorder). The theoretical value of ΔS is the entropy of hydrogen gas, which is close to −135 J mol⁻¹ K⁻¹. It is interesting to see that the alloys with more equal C14 and BCC abundances (P13 and P14) do not have the highest ΔS value. Instead, alloys P10 and P11, with a high density of BCC/C14 grain boundaries have the highest ΔS.

### Electrochemical Characterization

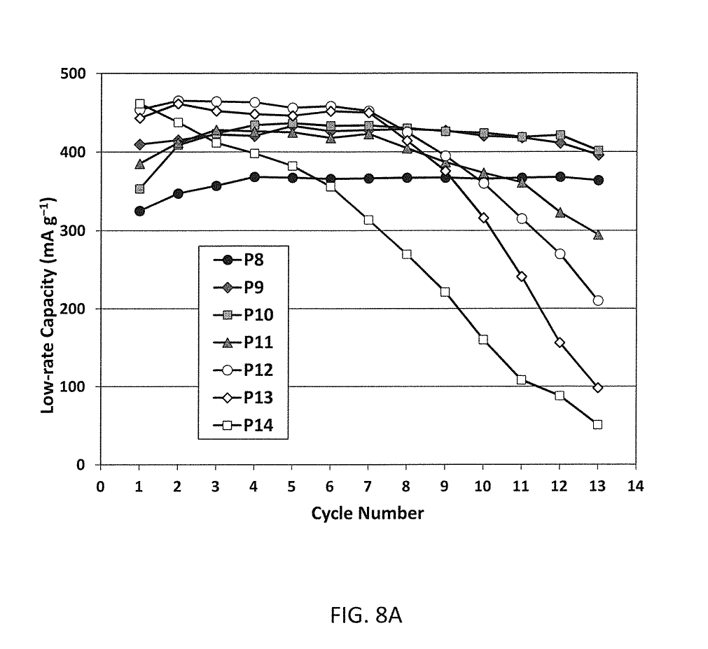

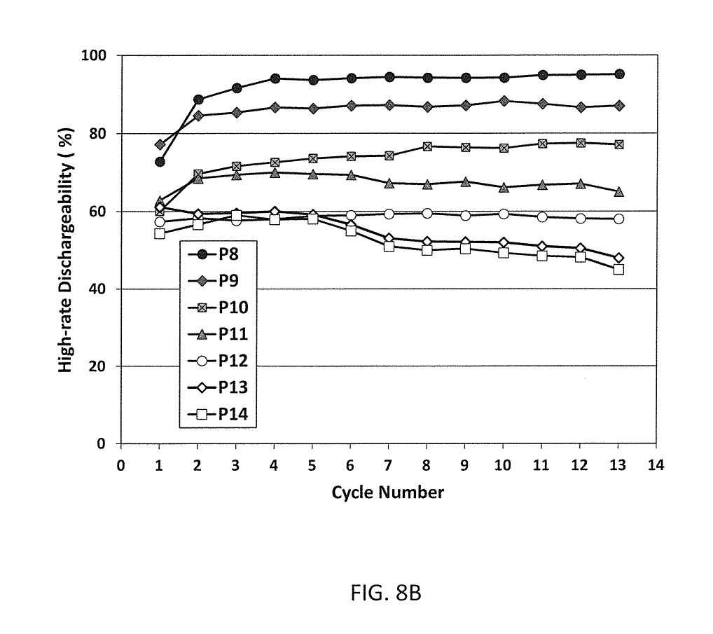

The discharge capacity of each alloy was measured in a flooded-cell configuration against a partially pre-charged Ni(OH)₂ positive electrode. For the half-cell electrochemical studies, each ingot was first ground and then passed through a 200-mesh sieve. The sieved powder was then compacted onto an expanded nickel metal substrate by a 10-ton press to form a test electrode (about 1 cm² in area and 0.2 mm thick) without using any binder. This allowed improved measurement of the activation behavior. Discharge capacities of the resulting small-sized electrodes were measured in a flooded cell configuration using a partially pre-charged Ni(OH)₂ pasted electrode as the positive electrode and a 6M KOH solution as the electrolyte. Each sample electrode was charged at a constant current density of 50 mA/g for 10 h and then discharged at a current density of 50 mA/g followed by two pulls at 12 and 4 mA/g. The full capacities (4 mA/g) from the first 13 cycles are plotted in FIG. 8A to study the activation and cycling behavior of these alloys. The activation of the alloys becomes easier with the decrease in BCC phase abundance and the Cr-content due to the corrosion resistance of BCC phase compared to C14 phase and the corrosion resistance of Cr against KOH. Reduction in the corrosion resistance helps activation; however, it also reduces cycle stability.

Capacities from 50 and 4 mA g⁻¹ discharge rates measured at the 4^{th} and 2^{nd} cycle, respectively, are listed in Table 8.

TABLE 8
Summary of electrochemical properties

| | 4^{th} cycle | 4^{th} cycle | | | | | |
|---|---|---|---|---|---|---|---|
| | cap | cap | | | Diffusion | Exchange | Open |
| | @ 50 mA | @ 4 mA | | Activation | coefficient | current | circuit |
| | g⁻¹ | g⁻¹ | 4^{th} cycle | cycle to reach | @ RT | @ RT | voltage |
| | (mAh g⁻¹) | (mAh g⁻¹) | HRD | max. cap. | (10⁻¹⁰ cm² s⁻¹) | (mA g⁻¹) | (V) |
| P8* | 166.7 | 172.0 | 0.989 | 2 | 1.54 | 33 | 1.354 |
| P8 | 346.5 | 368.2 | 0.941 | 4 | 1.38 | 31 | 1.289 |
| P9 | 364.3 | 420.3 | 0.867 | 5 | 1.33 | 30 | 1.277 |
| P10 | 321.0 | 434.1 | 0.726 | 5 | 1.32 | 23 | 1.276 |
| P11 | 298.1 | 426.0 | 0.700 | 3 | 1.28 | 26 | 1.274 |
| P12 | 258.8 | 463.1 | 0.580 | 2 | 1.57 | 17 | 1.262 |
| P13 | 268.8 | 448.2 | 0.600 | 2 | 1.81 | 11 | 1.251 |
| P14 | 230.5 | 398.2 | 0.578 | 1 | 1.62 | 15 | 1.257 |

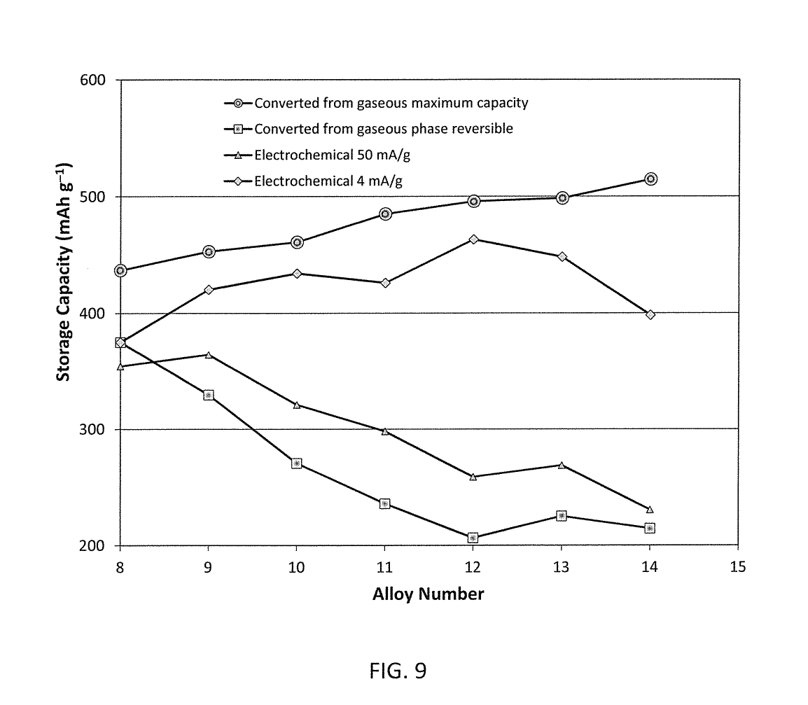

Both capacities increase and then decrease with increasing overall Ti-content. The highest capacity, 463 mAh/g, was measured with alloy P12. When the gaseous phase capacity is converted to a theoretical electrochemical capacity and plotted against the alloy number alongside the measured electrochemical storage capacities, the 4 mA/g (low rate) curve tracks the maximum gaseous phase capacity and the 50 mA/g (high rate) curve tracks the reversible gaseous phase capacities (FIG. 9). In this plot, the gaseous phase capacity is converted to electrochemical capacity by:

1 wt. % of H₂=268 mAh g⁻¹ (3)

The electrochemical capacities of this series of alloys fall between the boundaries set by the maximum and reversible gaseous phase capacities similar to other MH systems after subjecting the samples to full activation by the 5 MPa hydrogenation process.

Half-cell HRD values of each alloy, defined as the ratio of discharge capacity measured at 50 mA/g to that measured at 4 mA/g, are measured at the stabilized 4^{th} cycle and listed in Table 8. Except for P10, HRDs of all alloys are stabilized within 4 cycles. As the Ti-content in the alloy increases, HRD decreases rapidly. The increase in the catalytic C14 phase abundance does not help the HRD performance. Comparing the HRD of P8* and P8, we find that the electrochemical HRD in P8* is higher despite the lower hydrogen pressure used during activation and its lower reversibility in the gaseous phase (FIG. 7A). We can attribute this observation to the different phases in the alloys. The two pressure plateaus observed in the PCT curves can be associated with two different phases. The first phase with lower plateau pressure (from 0.3 to 1.0 wt. % in FIG. 7A) has better rate capability than the second phase (from 1.0 to 1.6 wt. % in FIG. 7A). C14 phase is believed to be more catalytic than BCC phase. Therefore, we assign the phase with lower plateau pressure to the C 14 phase and the phase with higher plateau pressure to the BCC phase. The increasing range of the first plateau is consistent with the increase in C14 phase abundance, and the decreasing range of the second plateau is consistent with the decrease in BCC phase abundance derived in the XRD analysis (Table 4).

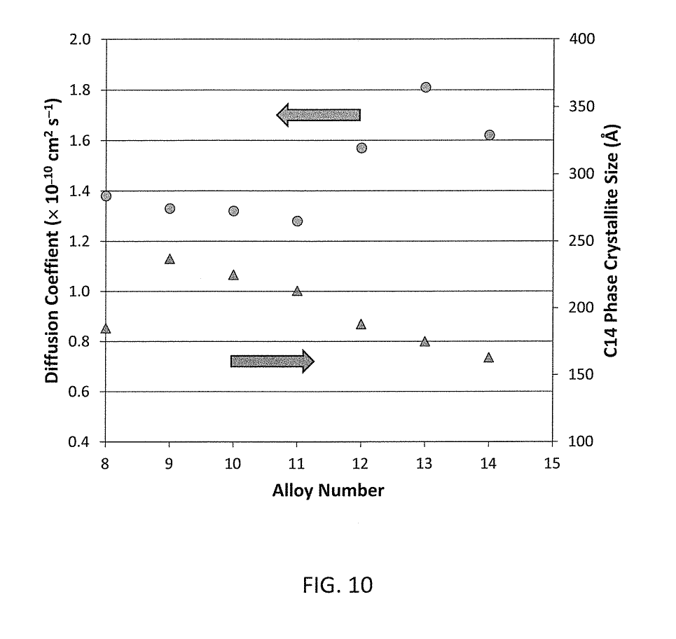

In order to study the reason for the HRD decrease with increased Ti-content, both bulk diffusion coefficient (D) and surface exchange current (I₀) were measured electrochemically. The details of both measurements were previously reported by F. Li, K. Young, T. Ouchi, M. A. Fetcenko, J. Alloys Compd. 471 (2009) 371-7, and the values are listed in Table 8. The D value and the C14 crystallite size are plotted against the alloy numbers in FIG. 10. The D value tends to increase with increasing Ti-content while the C14 crystallite size tends to decrease. This general trend indicates that smaller crystallite sizes of catalytic C14 allow the formation of more inter-granular zones that facilitate proton transfer and increase D value.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. A Laves phase-related BCC metal hydride alloy of comprising the composition of Formula I:
Ti_{w}VₓCr_{y}M_{z} (I)
where w+x+y+z=1, 0.1≦w≦0.6, 0.1≦x≦0.6, 0.01≦y≦0.6, and M is selected from the group consisting of B, Al, Si, Sn and transition metals,
said metal hydride alloy having a capacity in excess of 350 milliamperes per gram at cycle 10.

2. The alloy of claim 1 having a capacity of 400 milliamperes per gram or greater.

3. The alloy of claim 1 having a capacity of 420 milliamperes per gram or greater.

4. The alloy of claim 1 comprising less than 24% C14 phase.

5. The alloy of claim 1 wherein said metal hydride alloy is predominantly a combination of BCC phase and Laves phase, said BCC phase in abundance of greater than 5% and less than 95%, said Laves phase in abundance of greater than 5% and less than 95%.

6. The alloy of claim 1 comprising a BCC phase crystallite size of less than 400 angstroms.

7. The alloy of claim 1 comprising a BCC phase crystallite size of less than 200 angstroms.

8. The alloy of claim 1 comprising a B/A ratio of 1.20 to 1.31.

9. The alloy of claim 1 where x/y is from 1 to 3.

10. The alloy of claim 1 comprising a composition of Formula II:
Ti_{13.6+x}Zr_{2.1}V₄₄Cr_{13.2-x}M_{27.1} (II)
where x is a value in excess of 0 and 12 or less, and M is a combination of Mn, Fe, Co, Ni, and Al.

11. The alloy of claim 10 where x is 2, 4, 6, 8, 10 or 12.

12. The alloy of claim 10 where x is 2 or 4.
